(19) United States
(12) Patent Application Publication
(10) Pub. No.: US 2023/0069676 A1
(43) Pub. Date: Mar. 2, 2023

(54) BLOCKCHAIN-BASED MINING METHOD, MINING DEVICE, COMPUTER EQUIPMENT AND STORAGE MEDIUM

(71) Applicant: SOUTHERN UNIVERSITY OF SCIENCE AND TECHNOLOGY, Shenzhen City (CN)

(72) Inventors: Xuan SONG, Shenzhen City (CN); Haoran ZHANG, Shenzhen City (CN)

(73) Assignee: SOUTHERN UNIVERSITY OF SCIENCE AND TECHNOLOGY, Shenzhen City (CN)

(21) Appl. No.: 17/463,891

(22) Filed: Sep. 1, 2021

(51) Int. Cl. H04L 9/32; G06F 16/23; H04L 9/30; G06Q 20/06

(52) U.S. Cl. CPC H04L 9/3236; G06F 16/2379; H04L 9/30; G06Q 20/0655

(57) ABSTRACT

The invention disclose a blockchain-based mining method, mining device, computer equipment and storage medium. The method comprises: acquiring block header information of a to-be-generated block published by a mining pool; generating a random term based on a public key of the mining pool, a public key of the miner, POW of the miner and physical interaction information broadcast by other miners in the mining pool; calculating a to-be-verified hash value based on the block header information and the random term; if the to-be-verified hash value satisfies block generation condition, transmitting the to-be-verified hash value to the mining pool, so the mining pool generates the to-be-generated block after the to-be-verified hash value passes verification. In this invention, utilizing physical interaction information among miners to generate the random terms, so the original random terms which need to be generated at high-speed randomly are replaced, avoiding wasting computing power and electric power.

### TECHNICAL FIELD

The embodiments of the present invention relate to the technical field of blockchain, in particular to blockchain-based mining method, mining device, computer equipment and storage medium.

### BACKGROUND

The blockchain network needs to ensure the consistency of the blockchain state and the change thereof at any moment in the network, which needs the transaction set (namely, block) generated at any moment in the entire network to be unique. However, in a point-to-point (P2P) network, any node has the right to generate a new block on the basis of a previous block, which makes it possible for the newly generated block to change the state of the whole network from any moment, thereby destroying the consistency of the ledger in the network.

In the prior art, the uniqueness of the block newly generated at a certain moment and accepted by the network is ensured by a consensus mechanism, wherein the most common consensus mechanism is a Proof of Work (POW) mechanism. However, the POW consensus process is highly dependent on the computing power contributed by the blockchain network node, and the computing power are mainly used for solving the process of Secure Hash Algorithm (SHA)-256 Hash and random number search, without generating any practical social value, thereby wasting a large amount of computing power resources and wasting a large amount of power resources.

### DISCLOSURE OF INVENTION

The embodiments of the present invention provide a blockchain-based mining method, mining device, computer equipment and storage medium, so as to reduce resource waste caused in mining process.

In a first aspect, an embodiment of the present invention provides a blockchain-based mining method, applied to a miner, comprising:

acquiring block header information of a to-be-generated block that is published by a mining pool;

generating a random term based on a public key of the mining pool, a public key of the miner, POW of the miner and physical interaction information broadcast by other miners in the mining pool;

calculating a to-be-verified hash value based on the block header information and the random term; and

if the to-be-verified hash value satisfies block generation condition, transmitting the to-be-verified hash value to the mining pool, so that the mining pool generates the to-be-generated block after the to-be-verified hash value passes verification.

In a second aspect, an embodiment of the present invention provides a blockchain-based mining device, applied to a miner, comprising:

an information acquisition module for acquiring block header information of a to-be-generated block as published by a mining pool;

a random term generation module for generating random terms based on a public key of the mining pool, a public key of the miner, POW of the miner, and physical interaction information broadcast by other miners in the mining pool;

a hash value calculation module for calculating a to-be-verified hash value based on the block header information and the random term; and

a hash value transfer module for transferring the to-be-verified hash value to the mining pool if the to-be-verified hash value satisfies the block generation condition, so that the mining pool generates the to-be-generated block after the to-be-verified hash value passes verification.

In a third aspect, an embodiment of the present invention provides a computer equipment, comprising:

one or more processors;

a memory for storing one or more programs;

when executed by the one or more processors, the one or more programs enable the one or more processors to implement the blockchain-based mining method provided by any embodiment of the present invention.

In a fourth aspect, an embodiment of the present invention further provides a computer-readable storage medium having a computer program stored thereon, wherein the program, when executed by a processor, implements the blockchain-based mining method provided by any embodiment of the present invention.

The embodiment of the invention provides a blockchain-based mining method, which is applied to a miner, and firstly, on one hand, acquiring the block header information of the to-be-generated blocks that are published by the mining pool, and on the other hand, generating random terms based on the public key of the mining pool, the miner's own public key and the POW and the physical interaction information broadcast by other miners in the mining pool, then calculating the to-be-verified hash value based on the obtained block header information and the generated random terms, and transmitting the to-be-verified hash value to the mining pool when the to-be-verified hash value satisfying the block generation condition is obtained through calculation, so that the mining pool verifies the to-be-verified hash value, and generates the to-be-generated block after the verification is passed. According to the method provided by the embodiment of the invention, the random terms are generated by utilizing the physical interaction information among miners, so that the original random terms which need to be generated at high speed randomly are replaced, the problems of computing power and electric power waste caused by carrying out a large number of hash operations and random number searching process are avoided, and meanwhile, by setting the mining pool to only publish the block header information, and after verifying the to-be-verified hash value, the blocks are generated, so that the mining pool only needs to consume little bandwidth and power to obtain a certain reward, and thus helping to encourage venues with wireless Internet access (WIFI) capabilities to become mining pools actively.

### BRIEF DESCRIPTION OF THE DRAWINGS

FIG. 1 is a flowchart of a blockchain-based mining method according to Embodiment Iof the present invention;

FIG. 2 is a flowchart of a blockchain-based mining method according to Embodiment II of the present invention;

FIG. 3 is a schematic structural diagram of a blockchain-based mining device according to Embodiment III of the present invention;

FIG. 4 is a schematic structural diagram of a computer equipment according to Embodiment IV of the present invention.

### DETAILED DESCRIPTION

The present invention will be described in further detail with reference to the drawings and embodiments. It is to be understood that the specific embodiments described herein are merely illustrative of the present invention and are not to be construed as limiting the invention. It should be further noted that, for the convenience of description, only some structures related to the present invention are shown in the drawings, not all of them.

Before discussing exemplary embodiments in greater detail, it should be noted that some exemplary embodiments are described as processes or methods depicted as flowcharts. Although the flowcharts may describe the steps as a sequential process, many of the steps can be performed in parallel, concurrently, or simultaneously. In addition, the order of the steps may be rearranged. The process may be terminated when its operations are completed, but could have additional steps not included in the drawings. The processes may correspond to methods, functions, procedures, subroutines, subprograms, etc.

### Embodiment I

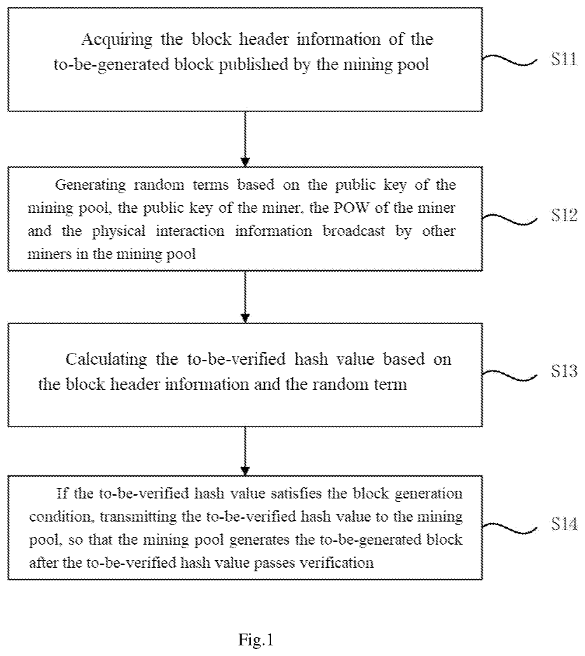

FIG. 1 is a flowchart of a blockchain-based mining method according to Embodiment I of the present invention. The present embodiment is applicable to blockchain-based mining by miners in a mining pool system established at any fixed location, and the method may be executed by the blockchain-based mining device provided by the embodiments of the present invention, the mining device can be implemented by hardware and/or software, and may be generally integrated into computer equipment, and the computer equipment may be but is not limited to various personal computers, notebook computers, smart phones, tablet computers, portable wearable equipment and the like. As shown in FIG. 1, the method specifically comprises the following steps:

S11, acquiring the block header information of the to-be-generated block published by the mining pool.

Specifically, before the block header information is published by the mining pool, a package transaction may be selected from the undetermined transaction pool, and the block size, the number of block transactions, the transaction list, constants in the block header, etc in the block structure of the to-be-generated block are obtained, where the constants in the block header may include a version number and a parent block hash value. Optionally, when selecting transactions from the undetermined transaction pool, transactions with higher commission may be preferentially selected as much as possible.

Optionally, before acquiring the block header information, the miner may first establish connection with the mining pool, specifically by making a connection request to the mining pool and completing a login to the mining pool after the pool responds to the request, and then after the mining pool has assigned the block generation task, the block header information of the to-be-generated block can be obtained, which may include all the information used to construct the block header of the to-be-generated block except for the random term.

S12, generating random terms based on the public key of the mining pool, the public key of the miner, the POW of the miner and the physical interaction information broadcast by other miners in the mining pool.

Optionally, the physical interaction information is periodically broadcast by other miners through the wireless internet access system. Specifically, miners in the mining pool may interact with each other in a physical interaction manner, for example, the physical interaction process may be an interaction process after connection is performed through a wireless hotspot of the mobile terminal and the like, that is, direct communication between the mobile terminal and the mobile terminal is realized. The specific process can refer to a broadcasting function of an Wireless Access Point (AP), one end serving as broadcast information can add interactive information carried in a predefined instruction into a Beacon frame (Beacon) or other data packets through the predefined instruction broadcasting function and broadcast outwards periodically, and one end serving as information receiving end can turn on a WIFI access function periodically, scan surrounding AP information, and, store data and execute other required logic functions when the predefined instruction is obtained.

When the physical interaction information broadcasted by other miners is received, the physical interaction information may be stored, and when the block header information is obtained for a mining task, the stored physical interaction information may be used for generating random terms, and meanwhile, the public key of the mining pool and the public key and POW of the miner who is mining are also used to generate the random terms. Specifically, the order of each item in the random terms may be, in turn, the public key of the mining pool, the public key of the miner, the POW of the miner, and physical interaction information broadcast by other miners, so as to identify that the current random term is generated by the miner himself ranked first. The physical interaction information may be the public key corresponding to other miners broadcasting the information, and may be used to identify in the random term the mining tasks in which other miners corresponding to the public key have participated, for distribution of subsequent rewards.

Optionally, the physical interaction information includes: public keys and POW of other miners. Specifically, there may be malicious miners in a mining pool that only disseminate their public key information to others through physical interaction without fulfilling the obligation to mine. Therefore, the probability of acquiring the reward by the malicious miners can be kept without consuming their own computing resource. When the physical interaction information used for generating the random term comprises the public key and the POW, other miners who can distribute the current mining reward must have participated in the mining task and contributed their own computing power, thus improving the fairness of subsequent reward distribution and also increasing the motivation of each miner to mine.

S13, calculating the to-be-verified hash value based on the block header information and the random term.

S14, if the to-be-verified hash value satisfies the block generation condition, transmitting the to-be-verified hash value to the mining pool, so that the mining pool generates the to-be-generated block after the to-be-verified hash value passes verification.

Specifically, the secure hash algorithm SHA-256 may be used to calculate a to-be-verified hash value of a block header formed by the block header information and the random term. Meanwhile, the block generation difficulty can be reduced, and illustratively, when two or three zeros appear in the to-be-verified hash value, the block generation condition can be determined to be satisfied. Since the update of the random term depends on the physical interaction information broadcast by other miners, the time required for block generation can be adjusted by reducing the difficulty of block generation.

And when the calculated to-be-verified hash value satisfies the block generation condition, transmitting the to-be-verified hash value to the mining pool, which further verifies whether the to-be-verified hash value can satisfy the block generation condition or not by the mining pool, if it is satisfied, and it is the first to-be-verified hash value received by the mining pool that satisfies the block generation conditions, generating a to-be-generated block and broadcasting to all miners in the mining pool, thereby terminating the mining task for the current block and starting the mining task for the next block.

Optionally, after the to-be-verified hash value is calculated based on the block header information and the random term, the method further includes: if the to-be-verified hash value does not satisfy the block generation condition, adjusting the ordering of the physical interaction information transmitted by other miners in the random term to generate a new random term; and recalculating the to-be-verified hash value based on the block header information and the new random term.

Specifically, when the calculated to-be-verified hash value does not satisfy the block generation condition, the random term needs to be updated, but the random term is not randomly generated out of thin air, but depends on physical interaction information broadcast by other miners. On one hand, miners may regenerate random terms through newly received physical interaction information broadcasted by other miners, and on the other hand, the ordering of the physical interaction information contained in the original random terms can be adjusted to regenerate the random terms, so that the possible number of the random terms is increased, and the possibility of satisfying the block generation condition is improved. Then, the process of generating a new random term and calculating the to-be-verified hash value based on the block header information and the new random term may be repeated until the calculated to-be-verified hash value can satisfy the block generation condition or a message that the block generation is completed broadcasted by the mining pool is received, and the like.

Based on the above technical solution, optionally, the miner may have two types of accounts including a mining account and a transaction account, wherein the transaction account is used for transaction, the public-private key pair used may be the same as a public-private used in the prior art, and the mining account is used for mining, the length of public-private key pair used is longer, illustratively, the length of the public-private key pair of the mining account is hundreds of times of that of the public-private key pair of the transaction account, so that the existing mining machine generates a public-private key pair nearly ten minutes or the time for generating the public-private key pair is longer than the time for generating a single block, and the like, thereby improving the difficulty for creating the public-private key pair of the mining account, and the storage of the public-private key pair requires a certain amount of storage space, which prevents malicious miners from adopting large-scale computers to mine by constantly creating accounts and then automatically generating random terms of block headers, meanwhile, a certain amount of calculation time is needed for establishing a large number of accounts, so that the feasibility of mining by repeatedly generating accounts by adopting large-scale computers is reduced. In contrast, it is more suitable for multi-user participation, and can be a device with certain storage capacity and simple physical interaction, for example, a mobile phone, a mobile tablet computer and the like, and each user only needs to create his own mining account once to continue the mining process, thus reducing the cost of creating a mining account per user.

The technical solution provided by the embodiment of the invention is applied to a miner, and firstly, on one hand, acquiring the block header information of the to-be-generated blocks that are published by the mining pool, and on the other hand, generating random terms based on the public key of the mining pool, the miner's own public key and the POW and the physical interaction information broadcast by other miners in the mining pool, then calculating the to-be-verified hash value based on the obtained block header information and the generated random terms, and transmitting the to-be-verified hash value to the mining pool when the to-be-verified hash value satisfying the block generation condition is obtained through calculation, so that the mining pool verifies the to-be-verified hash value, and generates the to-be-generated block after the verification is passed. According to the method provided by the embodiment of the invention, the random terms are generated by utilizing the physical interaction information among miners, so that the original random terms which need to be generated at high speed randomly are replaced, the problems of computing power and electric power waste caused by carrying out a large number of hash operations and random number searching process are avoided, and meanwhile, by setting the mining pool to only publish the block header information, and after verifying the to-be-verified hash value, the blocks are generated, so that the mining pool only needs to consume little bandwidth and power to obtain a certain reward, and thus helping to encourage venues with WIFI capabilities to become mining pools actively.

### Embodiment II

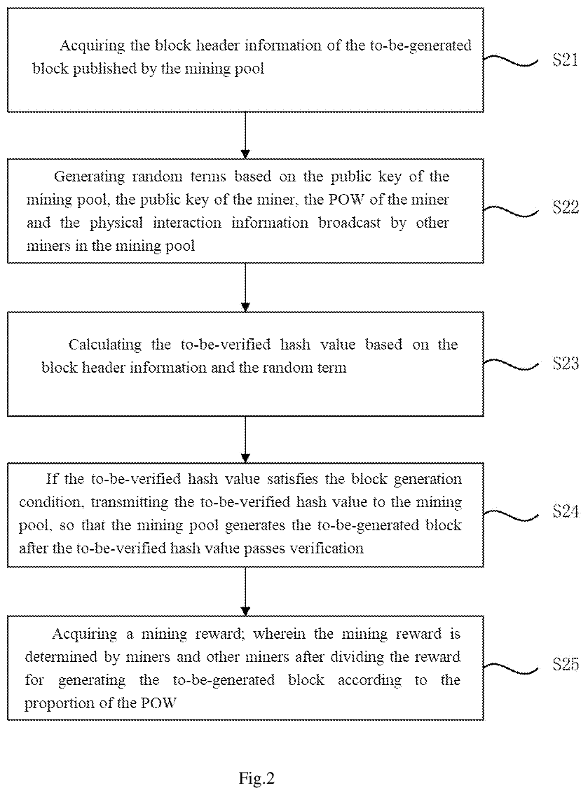

FIG. 2 is a flowchart of a blockchain-based mining method according to Embodiment II of the present invention. The technical solution of the present embodiment is further refined on the basis of the above technical solution, and optionally, on the basis that the physical interaction information comprises public keys and POW of other miners, the reward mechanism after completion of the block generation is further optimized. Specifically, in the present embodiment, after enabling the mining pool to generate the to-be-generated block after the verification of the to-be-verified hash value is passed, the method further includes: acquiring a mining reward; wherein the mining reward is determined by miners and other miners after dividing the reward for generating the to-be-generated block according to the proportion of the POW. Accordingly, as shown in FIG. 2, the method specifically includes the following steps:

S21, acquiring the block header information of the to-be-generated block published by the mining pool.

S22, generating random terms based on the public key of the mining pool, the public key of the miner, the POW of the miner and the physical interaction information broadcast by other miners in the mining pool.

S23, calculating the to-be-verified hash value based on the block header information and the random term.

S24, if the to-be-verified hash value satisfies the block generation condition, transmitting the to-be-verified hash value to the mining pool, so that the mining pool generates the to-be-generated block after the to-be-verified hash value passes verification.

S25, acquiring a mining reward; wherein the mining reward is determined by miners and other miners after dividing the reward for generating the to-be-generated block according to the proportion of the POW.

Specifically, the random term includes POW of the miner and other miners who have physically interacted with the miner, and it is possible to determine which miners participate in the process of mining and provide contribution of computing power, so that rewards obtained by generating the to-be-generated blocks can be evenly distributed in proportion according to contribution degrees of the POW of each miner. Wherein the POW of other miners may belong to the mining process of the current block or the mining process of the past blocks. Optionally, the farther the block corresponding to other miners' POW is from the current block, the lower the proportion of rewards available, i.e., the reward obtained by generating the to-be-generated block is more reasonably distributed according to the proportion of the POW and the distance between the block where the POW are located and the current block.

Optionally, acquiring the mining reward comprises: claiming the mining reward, and acquiring the mining reward when the claim of the miner and other miners reaches a preset claim proportion. Specifically, after the completion of block generation and distribution of the rewards available to individual miners, it is also necessary for individual miners to claim the rewards, which can be specifically achieved by sending a claim request to the mining pool, and only when all the miners who can be assigned rewards claim the rewards up to a preset proportion of claims, the claims of the rewards for generating the to-be-generated block can be considered as legitimate claims, and the corresponding rewards can be transferred to the account of each miner, wherein the preset claim proportion can be ninety percent or ninety-five percent and the like. Because malicious miners may exist in the mining pool, only the public key and the POW of the miner are contained in the process of generating the random term, and the physical interaction information of other miners is replaced by the random number, namely it is equivalent to the situation that the random term contains a plurality of illegal accounts, thus employing large-scale computers for mining, and by designing a claim mechanism, if the random terms contains a plurality of illegal accounts, the mining reward cannot be obtained even if the mining succeeds.

Optionally, the reward for generating the to-be-generated block is proportional to the number of ledgers contained in the to-be-generated block. Specifically, when the mining pool packages transactions, the more the number of ledgers included in the mining pool is, the more rewards that can be obtained for generating the to-be-generated blocks, so that the mining pool can be encouraged to package more ledgers, meanwhile, in order to reduce the time delay of miners for acquiring the information published by the mining pool, and the longest legal chain can be formed easily, and the mining pool can be encouraged to obtain more profits by increasing the bandwidth of the mining pool.

According to the technical solution provided by the embodiment of the present invention, by dividing the rewards of individual miners involved in mining in proportion to their respective POW, makes it possible for each user to receive less reward for block generation when there are more users involved in the division, thus reducing the economics of mining using large-scale computers, and further avoiding the problem of massive waste of computer computing power and electric power.

### Embodiment III

FIG. 3 is a schematic structural diagram of a blockchain-based mining device according to Embodiment III of the present invention, where the device may be implemented by hardware and/or software, and may be generally integrated into computer equipment for performing the blockchain-based mining method provided in any embodiment of the present invention, and the computer equipment may be, but is not limited to, various personal computers, notebook computers, smart phones, tablet computers, portable wearable devices, and the like. As shown in FIG. 3, the device includes:

an information acquisition module 31 for acquiring block header information of a to-be-generated block as published by a mining pool;

a random term generation module 32 for generating random terms based on the public key of the mining pool, the public key of the miner, the POW of the miner, and the physical interaction information broadcast by other miners in the mining pool;

a hash value calculation module 33 for calculating a to-be-verified hash value based on the block header information and the random term;

and a hash value transfer module 34 for transferring the to-be-verified hash value to the mining pool if the to-be-verified hash value satisfies the block generation condition, so that the mining pool generates the to-be-generated block after the to-be-verified hash value passes verification.

The technical solution provided by the embodiment of the invention is applied to a miner, and firstly, on one hand, acquiring the block header information of the to-be-generated blocks that are published by the mining pool, and on the other hand, generating random terms based on the public key of the mining pool, the miner's own public key and the POW and the physical interaction information broadcast by other miners in the mining pool, then calculating the to-be-verified hash value based on the obtained block header information and the generated random terms, and transmitting the to-be-verified hash value to the mining pool when the to-be-verified hash value satisfying the block generation condition is obtained through calculation, so that the mining pool verifies the to-be-verified hash value, and generates the to-be-generated block after the verification is passed. According to the method provided by the embodiment of the invention, the random terms are generated by utilizing the physical interaction information among miners, so that the original random terms which need to be generated at high speed randomly are replaced, the problems of computing power and electric power waste caused by carrying out a large number of hash operations and random number searching process are avoided, and meanwhile, by setting the mining pool to only publish the block header information, and after verifying the to-be-verified hash value, the blocks are generated, so that the mining pool only needs to consume little bandwidth and power to obtain a certain reward, and thus helping to encourage venues with WIFI capabilities to become mining pools actively.

Optionally, based on the above technical solution, the physical interaction information includes: public keys and POW of other miners.

Optionally, based on the above technical solution, the blockchain-based mining device further includes:

a reward acquisition module for acquiring a mining reward after enabling the mining pool to generate the to-be-generated block after the to-be-verified hash value of the mining pool passes verification; wherein the mining reward is determined by the miner and other miners after dividing the reward for generating the to-be-generated block according to the proportion of the POW.

Optionally, based on the above technical solution, the reward acquisition module includes:

a reward claim unit for claiming the mining reward and acquiring the mining reward when the claim of the miner and other miners reaches a preset claim proportion.

Optionally, based on the above technical solution, the reward for generating the to-be-generated block is proportional to the number of ledgers contained in the to-be-generated block.

Optionally, based on the above technical solution, the blockchain-based mining device further includes:

a new random term generation module for adjusting the ordering of the physical interaction information transmitted by other miners in the random term to generate a new random term if the to-be-verified hash value does not satisfy the block generation condition after calculating the to-be-verified hash value based on the block header information and the random term; and

a re-verification module for recalculating the to-be-verified hash value based on the block header information and the new random term.

Optionally, based on the above technical solution, the physical interaction information is periodically broadcast by other miners through a wireless internet access system.

The blockchain-based mining device provided by the embodiment of the present invention can execute the blockchain-based mining method provided by any embodiment of the present invention, and has corresponding functional modules and beneficial effects for executing the method.

It should be noted that, in the embodiment of the blockchain-based mining device, the various units and modules included are only divided according to the functional logic, but are not limited to the above division, as long as the corresponding functions can be realized; in addition, the specific names of the functional units are only for the convenience of distinguishing from each other, and are not used for limiting the scope of protection of the present invention.

### Embodiment IV

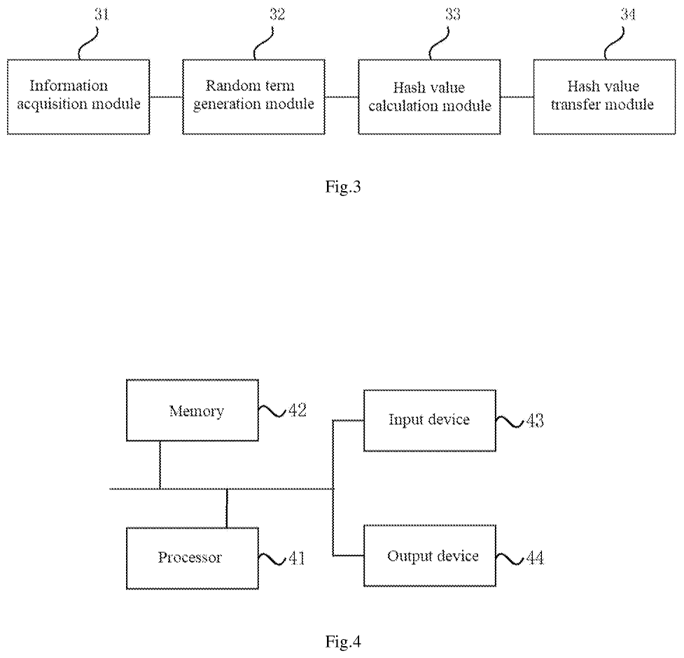

FIG. 4 is a schematic structural diagram of a computer equipment provided in Embodiment IV of the present invention, showing a block diagram of an exemplary computer equipment suitable for implementing the embodiment of the present invention. The computer equipment shown in FIG. 4 is merely an example, and should not impose any limitations to the function and the scope of use of the embodiments of the present invention. As shown in FIG. 4, the computer equipment includes a processor 41, a memory 42, an input device 43, and an output device 44; the number of the processors 41 in the computer equipment may be one or more, one processor 41 is taken as an example in FIG. 4, the processor 41, the memory 42, the input device 43 and the output device 44 in the computer equipment may be connected by a bus or other means, and the bus connection is taken as an example in FIG. 4.

The memory 42, as a computer readable storage medium, can be used to store software programs, computer executable programs, and modules, such as the program instructions/modules corresponding to the blockchain-based mining method in embodiments of the present invention (for example, the information acquisition module 31, the random term generation module, the hash value calculation module 33, and the hash value transfer module 34 in the blockchain-based mining device). The processor 41 executes various functional applications and data processing of the computer equipment by running the software programs, instructions and modules stored in the memory 42, i.e., implements the above-described blockchain-based mining method.

The memory 42 may primarily include a storage program area and a storage data area, wherein the storage program area may store an operating system, an application program required for at least one function; the storage data area may store data created according to use of the computer equipment, and the like. Further, the memory 42 may include High-Speed Random-Access memory, and may also include non-volatile memory, such as at least one magnetic disk storage device, flash memory device, or other non-volatile solid state storage device. In some examples, memory 42 may further include memory located remotely from processor 41, which may be connected to the mobile terminal through a network. Examples of such networks include, but are not limited to, the internet, corporate intranets, local area networks, mobile communication networks, and combinations thereof.

The input device 43 may be used to obtain the block header information of the to-be-generated blocks published by the mining pool and to generate key signal inputs related to user settings and function controls of the computer equipment, etc. The output device 44 may be used to transmit the calculated to-be-verified hash value to the mining pool, etc.

### Embodiment V

Embodiment V of the present invention further provides a storage medium containing computer-executable instructions, the computer-executable instructions, when executed by a computer processor, are used to perform a blockchain-based mining method, the method comprising:

acquiring the block header information of the to-be-generated block published by the mining pool;

generating random terms based on the public key of the mining pool, the public key of the miner, the POW of the miner and the physical interaction information broadcast by other miners in the mining pool;

calculating the to-be-verified hash value based on the block header information and the random term;

and if the to-be-verified hash value satisfies the block generation condition, transmitting the to-be-verified hash value to the mining pool, so that the mining pool generates the to-be-generated block after the to-be-verified hash value passes verification.

Storage medium-any of various types of memory devices or storage devices. The term “storage medium” is intended to include: mounting medium such as CD-ROM, floppy disk, or magnetic tape devices; computer system memory or Random-Access Memory such as DRAM, DDR RAM, SRAM, EDO RAM, Rambus RAM, etc.; non-volatile memory, such as flash memory, magnetic medium (e.g., hard disk or optical storage); registers or other similar types of memory elements, etc. The storage medium may also include other types of memory or combinations thereof. In addition, the storage medium may be located in the computer system in which the program is executed, or may be located in a different second computer system connected to the computer system through a network (such as the Internet). The second computer system may provide program instructions to the computer for execution. The term “storage medium” may include two or more storage medium that may reside in different locations (e.g., in different computer systems connected via a network). The storage medium may store program instructions (e.g., specifically implemented as a computer program) that are executable by one or more processors.

Of course, a storage medium comprising computer-executable instructions provided by the embodiment of the present invention contains computer-executable instructions that are not limited to the method of operations as described above, but may also perform the relevant operations in the blockchain-based mining method provided by any embodiment of the present invention.

The computer-readable signal medium may include a data signal propagated in a baseband or as part of a carrier wave that carries computer-readable program code. Such propagated data signals may take a variety of forms, including, but not limited to, electromagnetic signals, optical signals, or any suitable combination thereof. The computer-readable signal medium may also be any computer-readable medium other than a computer-readable storage medium that sends, propagates, or transmits a program for use by or in conjunction with an instruction execution system, device, or apparatus.

The program code contained on the computer readable medium may be transmitted using any appropriate medium, including but not limited to wireless, wireline, optical fiber cable, RF, etc., or any suitable combination of the foregoing.

From the above description of the embodiments, it will be clear to those skilled in the art that the present invention can be implemented by software and necessary general hardware, and certainly can be implemented by hardware, but the former is a preferred embodiment in many cases. Based on such understanding, the technical solutions of the present invention, which essentially or rather contributes to the prior art, may be embodied in the form of a software product, which can be stored in a computer readable storage medium, such as a computer floppy disk, Read-Only Memory (ROM), Random-Access Memory (RAM), FLASH Memory (FLASH), hard disk or optical disk, etc., including a number of instructions for enabling a computer equipment (which may be a personal computer, a server, or a network device, etc.) to perform the methods described in various embodiments of the present invention.

Note that the above are only the preferred embodiments of the present invention and the applied technical principles. Those skilled in the art will appreciate that the present invention is not limited to the particular embodiments described herein, and that various obvious changes, readjustments and substitutions will now be apparent to those skilled in the art without departing from the scope of the invention. Therefore, although the present invention has been described in some detail by the above embodiments, the present invention is not limited to the above embodiments, and may include other equivalent embodiments without departing from the spirit of the invention, and the scope of which is determined by the scope of the appended claims.

What is claimed is:

1. A blockchain-based mining method, applied to a miner, comprising:
acquiring block header information of a to-be-generated block that is published by a mining pool;
generating a random term based on a public key of the mining pool, a public key of the miner, POW of the miner and physical interaction information broadcast by other miners in the mining pool;
calculating a to-be-verified hash value based on the block header information and the random term; and
if the to-be-verified hash value satisfies block generation condition, transmitting the to-be-verified hash value to the mining pool, so that the mining pool generates the to-be-generated block after the to-be-verified hash value passes verification.

2. The blockchain-based mining method according to claim 1, wherein the physical interaction information comprises: a public key and POW of said other miners.

3. The blockchain-based mining method according to claim 2, wherein after the mining pool generating the to-be-generated block after the to-be-verified hash value passes verification, the method further comprises:
acquiring a mining reward; wherein the mining reward is determined by the miner and other miners after dividing the reward for generating the to-be-generated block according to the proportion of the POW.

4. The blockchain-based mining method according to claim 3, wherein the acquiring of the mining reward comprises:
claiming the mining reward, and acquiring the mining reward when claim of the miner and other miners reaches a preset claim proportion.

5. The blockchain-based mining method according to claim 3, wherein the reward for generating the to-be-generated block is proportional to the number of ledgers contained in the to-be-generated block.

6. The blockchain-based mining method according to claim 1, wherein after said calculating the to-be-verified hash value based on the block header information and the random term, the method further comprises:
if the to-be-verified hash value does not satisfy the block generation condition, adjusting the ordering of the physical interaction information transmitted by other miners in the random term to generate a new random term; and
recalculating the to-be-verified hash value based on the block header information and the new random term.

7. The blockchain-based mining method according to claim 1, wherein the physical interaction information is periodically broadcast by said other miners through a wireless internet access system.

8. A blockchain-based mining device, applied to a miner, comprising:
an information acquisition module for acquiring block header information of a to-be-generated block as published by a mining pool;
a random term generation module for generating random terms based on a public key of the mining pool, a public key of the miner, POW of the miner, and physical interaction information broadcast by other miners in the mining pool;
a hash value calculation module for calculating a to-be-verified hash value based on the block header information and the random term; and
a hash value transfer module for transferring the to-be-verified hash value to the mining pool if the to-be-verified hash value satisfies the block generation condition, so that the mining pool generates the to-be-generated block after the to-be-verified hash value passes verification.

9. A computer equipment, comprising:
one or more processors;
a memory for storing one or more programs;
when executed by the one or more processors, the one or more programs enable the one or more processors to implement the blockchain-based mining method of claim 1.

10. A computer equipment, comprising:
one or more processors;
a memory for storing one or more programs;
when executed by the one or more processors, the one or more programs enable the one or more processors to implement the blockchain-based mining method of claim 2.

11. A computer equipment, comprising:
one or more processors;
a memory for storing one or more programs;
when executed by the one or more processors, the one or more programs enable the one or more processors to implement the blockchain-based mining method of claim 3.

12. A computer equipment, comprising:
one or more processors;
a memory for storing one or more programs;
when executed by the one or more processors, the one or more programs enable the one or more processors to implement the blockchain-based mining method of claim 6.

13. A computer equipment, comprising:
one or more processors;
a memory for storing one or more programs;
when executed by the one or more processors, the one or more programs enable the one or more processors to implement the blockchain-based mining method of claim 7.

14. A computer-readable storage medium having a computer program stored thereon, wherein the program, when executed by a processor, implements the blockchain-based mining method according to claim 1.

15. A computer-readable storage medium having a computer program stored thereon, wherein the program, when executed by a processor, implements the blockchain-based mining method according to claim 2.

16. A computer-readable storage medium having a computer program stored thereon, wherein the program, when executed by a processor, implements the blockchain-based mining method according to claim 3.

17. A computer-readable storage medium having a computer program stored thereon, wherein the program, when executed by a processor, implements the blockchain-based mining method according to claim 6.

18. A computer-readable storage medium having a computer program stored thereon, wherein the program, when executed by a processor, implements the blockchain-based mining method according to claim 7.
